(19) United States
(12) Patent Application Publication
(10) Pub. No.: US 2008/0063506 A1
(43) Pub. Date: Mar. 13, 2008

(54) Cover plate for hydraulic rotating connector

(76) Inventor: Robin Dale Arrington, (US)

Correspondence Address: WOODS, ROGERS, P.L.C., 1505 LONDON ROAD, CHARLOTTESVILLE, VA, 22902-8681, US

(21) Appl. No.: 11/899,102

(22) Filed: Sep. 4, 2007

Related U.S. Application Data
(60) Provisional application No. 60/842,740, filed on Sep. 7, 2006.

(51) Int. Cl. B66F 9/075

(52) U.S. Cl. 414/787

(57) ABSTRACT

A cover plate that attaches to a hydraulic rotating connector on the side that faces towards the product being handled. A hydraulic rotating connector is mounted on the vertical boom of a lift truck when a rotating platform that extends forward from the boom has need to perform hydraulics functions. The purpose of the cover plate is to eliminate or greatly reduce hydraulic oil from coming in contact with product being handled.

### CROSS REFERENCE TO RELATED APPLICATION

This application claims priority from U.S. provisional application Ser. No. 60/842,740 filed Sep. 7, 2006.

### BACKGROUND OF THE INVENTION

This invention relates to a cover for a hydraulic rotating connector. The connector being used to direct hydraulic fluid from a stationary point to power hydraulic functions on a rotating platform.

### DESCRIPTION OF THE RELATED ART

There are forklifts or industrial trucks used to lift and move all kinds of products in all types of industries today. These forklifts or industrial trucks are equipped with different apparatuses for handling different materials. Some have a set of forks, some have a set of clamps and there are many other means used to attach to the product being moved.

The apparatus that comes in contact with product being moved is usually attached to a boom on a forklift or industrial truck that has movement on a vertical plane. The point of contact between the apparatus that comes in contact with the product being moved and the boom on the lift truck or fork lift can be a rigid connection or a rotating connection. When a rotating connection is used and there are hydraulic functions that need to be preformed, on a rotating platform, that extends beyond the boom of a fork lift or industrial truck, and be powered and controlled from the forklift or industrial truck, a rotating hydraulic connector is used.

A hydraulic rotating connector is usually comprised of a shaft, with a plurality of internal canals with openings at opposite ends. This shaft is usually mounted rigid. One end of the internal canals connects to hydraulic lines from the forklift or industrial truck

On the opposite end of the shaft, a block that has a depth usually shorter than the length of the shaft and the width and height being greater than the circumference of the shaft. The block is mounted to the shaft so that it has the ability to rotate. The block has a plurality of internal circularly canals that align with the canal openings on the shaft. The internal canals of the block have a plurality of open channels that exit the side of the block that hydraulic lines can be attached to.

The hydraulic rotating connector can perform different functions, such as supplying hydraulic force, controlling flow of hydraulic fluid, controlling amount of force applied etc. It can perform some or all of these functions.

Normally the end of the shaft that the block mounts on, opposite the end that receives the hydraulic lines from the forklift or industrial truck, extends beyond the block. This is the point where hydraulic oil leakage usually starts first, since this end faces towards the product being handled it can damage the product.

FIG. 3 in U.S. Pat. No. 4,435,119 illustrates a hydraulic rotating connector being used on a paper roll clamp. The hydraulic rotating connector is not identified with a number.

### SUMMARY OF THE INVENTION

A cover plate for a hydraulic rotating connector is described:

A cover plate that is mounted on a hydraulic rotating connector on the side that faces towards the products being handled to prevent damage to the products from hydraulic oil. The cover plate can be mounted to new or existing hydraulic rotating connectors.

The cover plate being thick enough so that cavities can be recessed in it, so the cavities can align with but not obstruct any objects protruding from the side of the hydraulic rotating connector that faces toward the product being handled.

The cover plate needs to have size enough to cover any area for potential leakage and a means of connecting it to the hydraulic rotating connector.

The cover plate will be connected to the hydraulic rotating connector with a plurality of bolts or screws arranged in a pattern that does not hinder the functions of the hydraulic connector.

The cover plate can have a channel or channels that accepts an o-ring or a plurality of o-rings for the purpose of sealing the point of contact between the cover plate and the hydraulic rotating connector. A solid gasket can be used or a flowable gasket material can be used.

There are many different sizes and models of hydraulic rotating connectors. Therefore the cover plate will have different versions.

An object of this invention is to make improvements on hydraulic rotating connectors.

An object of this invention is to eliminate or greatly reduce damage from hydraulic oil to products being handled with a fork lift or industrial truck using a hydraulic rotating connector.

### BRIEF DESCRIPTION OF THE DRAWINGS

FIG. 1. shows a side view of a hydraulic rotating connector and a cover plate

### ELEMENT LIST

1. Terminal that hydraulic lines from a fork lift or industrial truck attach to
2. Terminal that hydraulic lines from a fork lift or industrial truck attach to
3. Block mounted on the shaft that has the ability to rotate
4. Shaft
5. Terminals where hydraulic line can be connected to
6. Terminals where hydraulic line can be connected to
7. Terminals where hydraulic line can be connected to
8. Terminals where hydraulic line can be connected to
9. Threaded channel in block number three (3)
10. Threaded channel in block number three (3)
11. Cover plate that is attached to block number three (3)
12. Open channel in cover plate
13. Open channel in cover plate
14. Cavity in cover plate
15. Rigid mounted block

### DETAILED DESCRIPTION OF THE INVENTION

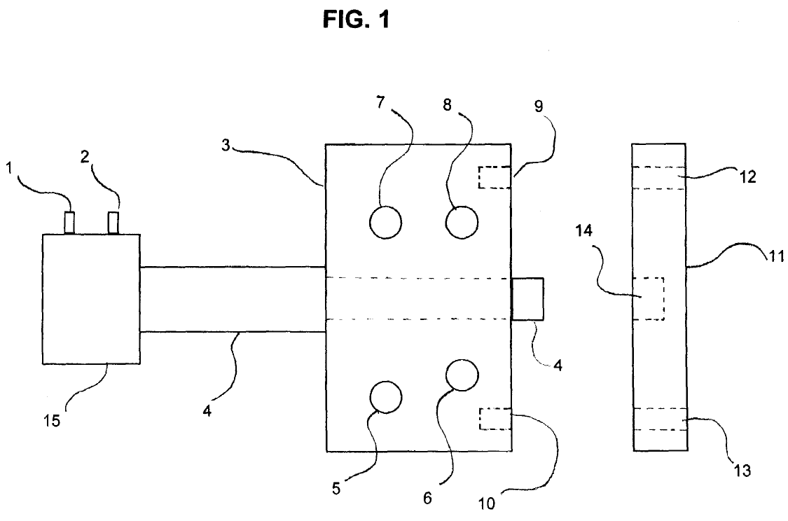

In FIG. 1 number one (1) block number fifteen (15) is attached rigid to shaft number four (4) block number fifteen (15) is mounted rigid facing towards the boom of the lift truck.

In FIG. 1 number one (1) and number two (2) are terminals where hydraulic lines from a lift truck are connected.

In FIG. 1 number three (3) is a block mounted on shaft number four (4) with the ability to rotate. Block number three (3) is mounted facing towards the product being handled.

In FIG. 1 number five (5) number six (6) number seven (7) and number eight (8) are terminals, where hydraulic lines can be connected to an apparatus or a plurality of apparatuses that require the use of hydraulics to perform their functions that are mounted on a rotating platform.

In FIG. 1 number eleven (11) is a plate that is attached to block number three (3)

In FIG. 1 number fourteen (14) is a cavity in plate number eleven (11). Cavity number fourteen (14) aligns with but is greater in volume than shaft number four (4) extending from block number three (3) on the side facing towards the product being handled.

In FIG. 1 number twelve (12) and number thirteen (13) are channels that bolts or screws pass through to threaded channels number nine (9) and number ten (10) for the purpose of connecting plate number eleven (11) to block number three (3)

The drawing FIG. 1 and the description are to show the purpose and function of the cover plate. They are not to scale. They do not limit the amount of hydraulic terminals, or the amount of bolts or screws used to attach cover plate to the hydraulic rotating connector or the number of cavities in the cover plate.

1-5. (canceled)

6. A cover for an hydraulic fluid driven rotating connector used in devices for moving products wherein the connector has at least one object passing therethrough and protruding from a product-facing side thereof and at least two threaded channels extending partially therethrough comprising:
a rigid plate having at least one cavity extending partially therethrough on the non-product facing side thereof wherein the at least one cavity is aligned with but greater in depth and width than the depth and width of the at least one object protruding from the connector and wherein further the non-product-facing side of said rigid plate has a cross-sectional area large enough to cover any site of possible hydraulic fluid leakage;
at least two channels extending through said rigid plate;
connecting means for attaching said rigid plate to the connector through said at least two channels;
sealing means for sealing the point of contact between said rigid plate and the connector; and

7. The cover of claim 1 wherein said connecting means are a plurality of bolts or screws.

8. The cover of claim 1 wherein said sealing means are at least one o-ring and the cover further includes at least one channel therein to accommodate each such o-ring.

9. The cover of claim 1 wherein said sealing means are at least one gasket and the cover further includes at least one channel therein to accommodate each such gasket.

10. The cover of claim 1 wherein said sealing means is a flowable gasket material.
